(19) United States
(12) Patent Application Publication
(10) Pub. No.: US 2026/0212116 A1
(43) Pub. Date: Jul. 23, 2026

(54) TRAINING AN ARTIFICIAL INTELLIGENCE CLASSIFIER USING LLM-LABELED TRAINING DATA

(71) Applicant: Camelot UK Bidco Limited, London (GB)

(72) Inventors: Amirhossein YOUSEFIRAMANDI, Barcelona (ES); Ciaran COONEY, Barcelona (ES); Saurabh MISHRA, Leamington Spa (GB)

(21) Appl. No.: 19/029,628

(22) Filed: Jan. 17, 2025

(51) Int. Cl. G06F 40/20

(52) U.S. Cl. CPC G06F 40/20

(57) ABSTRACT

System, methods, apparatuses, and computer program products are disclosed for generating and using an artificial intelligence classifier for classifying input into one or more nodes of a taxonomy. Labeled training data is received for at least a first portion of the taxonomy. For at least a second portion of the taxonomy having insufficient labeled training data, unlabeled training data is selected based on the second portion of the taxonomy. A large language model (LLM) is used to label the selected unlabeled training data to generate LLM-labeled training data. A machine learning (ML) model is trained using at least the LLM-labeled training data to classify input into a first level of the taxonomy.

### BACKGROUND

Classification of information into a taxonomy involves organizing and categorizing data into one or more nodes of a data structure based on shared characteristics or attributes. This may include classifying information into a hierarchical data structure of categories and subcategories, with each level of the hierarchy representing a progressively more specific level of detail. Artificial intelligence (AI) classification systems may leverage machine learning to classify information into one or more categories of a taxonomy.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for generating and using an artificial intelligence classifier for classifying input into one or more nodes of a taxonomy. Labeled training data is received for at least a first portion of the taxonomy. For at least a second portion of the taxonomy having insufficient labeled training data, a large language model (LLM) is used to label unlabeled training to generate LLM-labeled training data. A machine learning (ML) model is trained using at least the LLM-labeled training data to classify input into a first level of the taxonomy.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for generating an artificial intelligence (AI) classifier and classifying input using the generated AI classifier, in accordance with an embodiment.

FIG. 2 depicts a block diagram of an example system for generating an AI classifier in accordance with an embodiment.

FIG. 3 depicts a block diagram of an example system for classifying an input using an AI classifier, in accordance with an embodiment.

FIG. 4 depicts a flowchart of a process for training an ML model using LLM-labeled training data, in accordance with an embodiment.

FIG. 5 depicts a flowchart of a process for classifying an input into a first level of a taxonomy using an AI classifier, in accordance with an embodiment.

FIG. 6 depicts a flowchart of a process for classifying an input into a second level of a taxonomy using an AI classifier, in accordance with an embodiment.

FIG. 7 depicts a flowchart of a process for selecting unlabeled training data for labeling by a large language model (LLM), in accordance with an embodiment.

FIG. 8 depicts a flowchart of a process for generating a classification score for unlabeled training data, in accordance with an embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “taxonomy” refers a classification system that organizes entities into hierarchical or non-hierarchical structures based on shared characteristics. In embodiments, a “hierarchical taxonomy” may include a tree-like taxonomy where entities are grouped based on shared characteristics and organized into nested levels of increasing specificity. In embodiments, a “non-hierarchical taxonomy” may include a flat taxonomy where entities are organized into categories without imposing strict hierarchical (e.g., ancestor-descendant) relationship on the categories.

### II. Example Embodiments

Artificial intelligence (AI) classifiers are models designed for the systematic categorization of data into hierarchical taxonomies. These classifiers utilize machine learning and pattern recognition algorithms to automatically assign elements to one or more nodes of a taxonomy having broader categories subdivided into more specific subcategories. By leveraging features and characteristics of the data, AI classifiers are able to discern relationships and make predictions about the appropriate categories of a taxonomy.

Generating an AI classifier can be a complicated process requiring substantial knowledge and human input. For instance, to generate an AI classifier using machine learning techniques, a subject matter expert may need to provide appropriate labeled training data for each of the categories and/or subcategories of the taxonomy. In scenarios, the lack of high quality training data for some categories and/or subcategories of the taxonomy may impact the accuracy of the trained AI classifier.

Embodiments disclosed herein are directed to the generation and/or use of an artificial intelligence (AI) classifier that classifies data based on a classification generated by a machine learning (ML) model training based on LLM-labeled training data. The AI classifier is capable of classifying data into one or more nodes of a taxonomy without labeled training data for every category and/or subcategory of the taxonomy.

Generation of the AI classifier begins with a user-provided or predetermined taxonomy, that may include, but is not limited to, a category of the taxonomy, a subcategory of the taxonomy, a relationship between a category and subcategory of the taxonomy, a label (e.g., name, heading, etc.) of a category or subcategory of the taxonomy, and/or a brief description of the taxonomy. In embodiments, the taxonomy is provided by a client (e.g., user, subject matter expert, customer, script, etc.) through an interface (e.g., graphical user interface (GUI), application programming interface (API), etc.). In embodiments, the description or definition of the taxonomy is semi-automatically developed by providing a predetermined taxonomy to the user, and interacting with the user to modify the predetermined taxonomy. In embodiments, the generated taxonomy is represented as a set of nodes representative of categories and/or subcategories of the taxonomy, and a set of relationships representative of the relationship between an ancestor node and a descendent node in the taxonomy. In embodiments, nodes of the taxonomy are associated with a description (e.g., name, summary, etc.) of the category and/or subcategory represented by the node, and/or training data associated with the category and/or subcategory.

Training data for the categories and/or subcategories of the taxonomy is, in embodiments, provided by the client in various ways, such as, but not limited to, as textual data, as non-textual data, as a file, as an identifier (e.g., patent number, publication identifier, universal resource locator (URL), etc.), and/or the like. For instance, training data provided as patent numbers, publication identifiers, and/or URL may cause the retrieval of textual data (e.g., article, patent, etc.) associated therewith. In embodiments, training data provided as non-textual data (e.g., images, videos, audio, etc.) may be provided to a data processor (e.g., analyzer) to generate a textual description of the non-textual data. For instance, speech recognition may be employed to convert audio data into text, optical character recognition (OCR) may be employed to extract text from images and/or videos, image recognition may be employed to generate a textual description of the content of non-textual data, metadata (e.g., description, closed-caption text, etc.) may be extracted from the non-textual data. In embodiments, training data provided by the client can include, but is not limited to, labeled training data, and/or unlabeled training data.

In embodiments, user-provided labeled training data may include insufficient and/or no labeled training data for a first subset of the taxonomy, such as, but not limited to, a portion or all of taxonomy. In embodiments, unlabeled training data is selected based on a likelihood that the unlabeled training data belongs to the first subset of the taxonomy. In embodiments, the selected unlabeled training data is labeled using a large language model (LLM) to generate LLM-labeled training data that is then used to train one or more ML models to classify inputs into a level of the taxonomy.

In embodiments, a taxonomy manager selects unlabeled training data for labeling by the LLM based on a likely classification of the unlabeled training data. For instance, the taxonomy manager determines a node of the taxonomy with insufficient and/or not labeled training data, and selects unlabeled training data that likely belongs to the node of the taxonomy based on classification scores associated with the unlabeled training data. In embodiments, the taxonomy manager concatenates textual sections (e.g., abstract, description, conclusion, claims, etc.) of the unlabeled training data to generate concatenated text, and generates chunks from the concatenated text for scoring. In embodiments, the chunks are overlapping portions of the concatenated text. In embodiments, the taxonomy manager determines classification sub-scores for the chunks based on a distance (e.g., cosine distance, Euclidean distance, etc.) between an embedding of the chunks and an embedding of a textual description of the node of the taxonomy. In embodiments, the taxonomy manager determines classification scores for the unlabeled training data based on the classification sub-scores. For instance, the classification score for a piece of unlabeled training data is calculated in various ways, such as, but not limited to, as the highest classification sub-score of the chunks of the piece of unlabeled training data, as an average of the classification sub-scores of the chunks of the piece of unlabeled training data, and/or the like. In embodiments, the taxonomy manager ranks the unlabeled training data based on the classification scores for the node of the taxonomy and selects a number of unlabeled training data for the node of the taxonomy in order to achieve a labeled training data threshold. For instance, when a user provides some labeled training data for a node of the taxonomy that is below the training data threshold, the taxonomy manager selects pieces of unlabeled training data until the amount of training data for the node of the taxonomy satisfies the training data threshold.

In embodiments, the taxonomy manager provides the selected unlabeled training data along with the taxonomy to an LLM for labeling. For example, the taxonomy manager provides a textual prompt to the LLM requesting the LLM to label the unlabeled training data based on the taxonomy. In instances, an example prompt may include “Please label the following unlabeled training data using one or more categories in the following taxonomy.” In embodiments, the taxonomy manager receives LLM-labeled training data from the LLM, and provides the LLM-labeled training data along with user-provided labeled training data to a ML model trainer to train one or more ML models to classify an input into a level of the taxonomy.

The AI classifier comprises one or more trained ML models for classifying data into a level of the taxonomy. For instance, a first trained ML model is trained to determine a first level classification based on training data associated with the categories in a first level of the taxonomy. Subsequent to determining the first level classification for the data, the data is, in embodiments, provided to a second trained ML model that is trained to determine a second level classification based training data associated with subcategories in a second level of the taxonomy that are subordinate to the determined first level classification. Classifications for subsequent layers in the taxonomy are, in embodiments, determined in a similar manner by providing the data to a subsequent trained ML model that is trained to determine a subcategory classification based on training data associated with subcategories in a level of the taxonomy that are subordinate to the classification determined at the preceding level of the taxonomy.

In embodiments, the AI classifier classifies input data into one or more nodes of a taxonomy in a phased manner. For example, the AI classifier provides input data to a first ML model trained to classify an input into a first (e.g., top-most, etc.) level of a taxonomy, and receives, from the first ML model, a first level classification associated with a first node in the first level of the taxonomy. In embodiments, the AI classifier determines a second ML model trained to classify an input into a subset of nodes in a second (e.g., subordinate, etc.) level of the taxonomy that are subordinate to the first node. In embodiments, the AI classifier provides the input to the second ML model for classification, and receives, from the second ML model, a second level classification associated with a second node in the second level of the taxonomy. In embodiments, the AI classifier classifies the input into additional subordinate levels of the taxonomy by selecting a subsequent ML model, and receiving an additional level classification from the subsequent ML model. In embodiments, the AI classifier outputs an output classification for the input based on one or more of the level classifications.

The trained ML models, in embodiments, are trained using ML techniques based on labeled training datasets that comprise user-provided labeled training data and/or LLM-labeled training data. In embodiments, the labeled training dataset for training a first trained ML model to classify data into a first level of the taxonomy comprises the training data associated with nodes in the first level of the ML taxonomy labeled with an identifier (e.g., category name, category description, category identifier, etc.) of the associated nodes. In embodiments, nodes of the taxonomy may inherit training data from subordinate nodes in the taxonomy. The labeled training dataset, in embodiments, is divided into a first subset training dataset for training and a second subset validation dataset for validation. For instance, trained ML models are, in embodiments, trained by iteratively adjusting the parameters of the model to minimize a loss function between its predicted classification and the actual classification in the first subset training dataset. The performance of the model is then evaluated on the second subset validation dataset to assess its ability to accurately classify new or unseen data. The trained ML models are, in embodiments, generated based on various ML algorithms, such as, but not limited to, support vector machines (SVM), logistic regression, decision trees, random forest, k-nearest neighbors (KNN), Naïve Bayes, gradient boosting, neural networks, and/or the like.

These and further embodiments are disclosed herein that enable the functionality described above and additional functionality. Such embodiments are described in further detail as follows.

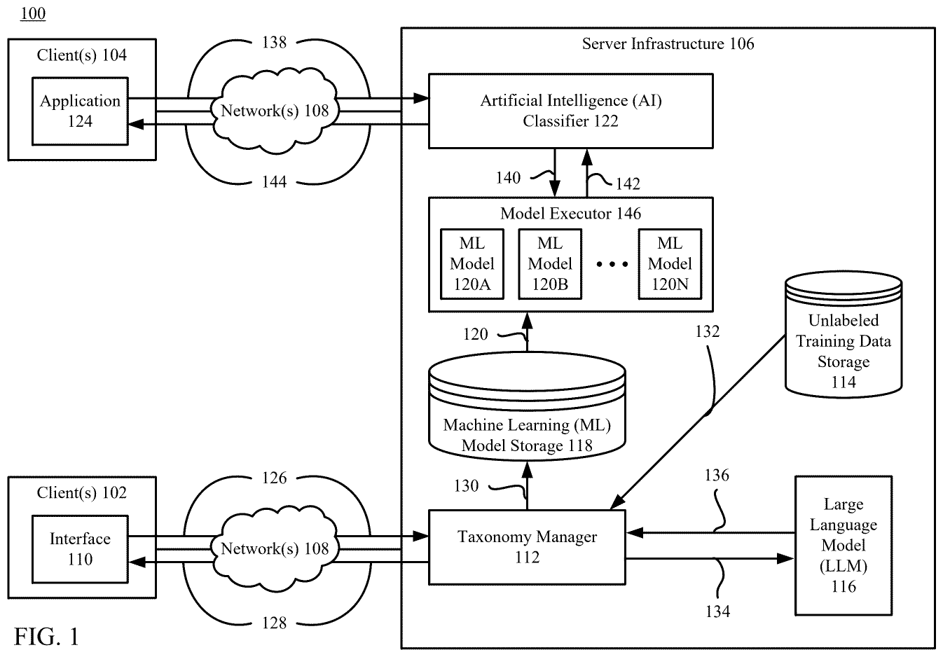

For instance, FIG. 1 depicts a block diagram of an example system 100 for generating an artificial intelligence (AI) classifier and classifying input using the generated AI classifier, in accordance with an embodiment. As shown in FIG. 1, system 100 includes one or more clients 102 and one or more clients 104 communicatively coupled to a server infrastructure 106 via one or more networks 108. Furthermore, client(s) 102 may include an interface 110, and client(s) 104 may include an application 124. Additionally, server infrastructure 106 may include a taxonomy manager 112, an unlabeled training data storage 114, an LLM 116, an ML model storage 118, one or more ML models 120 (e.g., ML model(s) 120A-120N), a model executer 146, and an AI classifier 122. System 100 is described in further detail as follows.

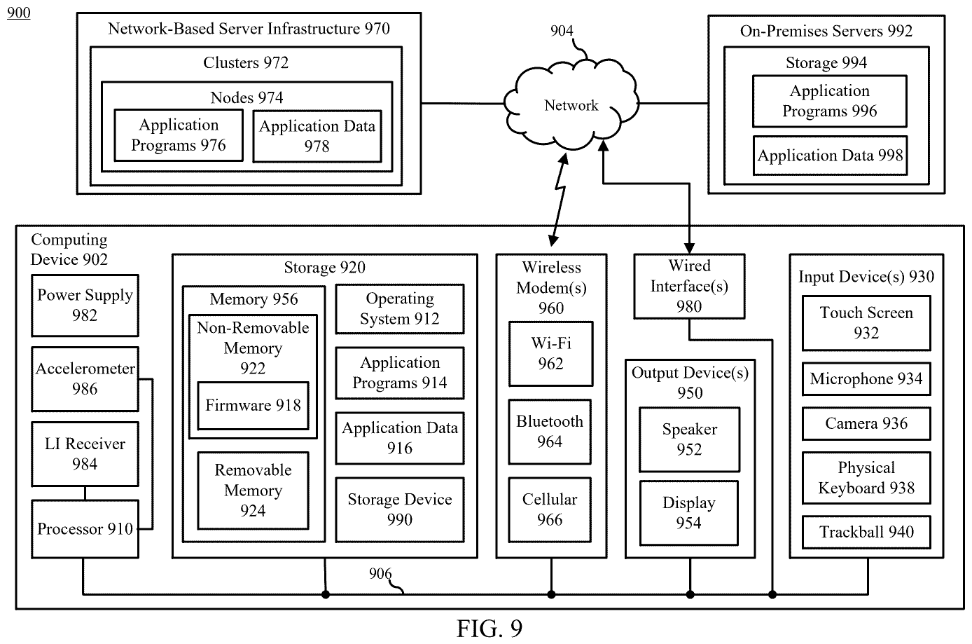

Client(s) 102 and/or 104 comprise any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. As shown in FIG. 1, client(s) 102 include interface 110, and client(s) 104 include application 124. Various example implementations of client(s) 102 and/or 104 are described below in reference to FIG. 9 (e.g., computing device 902, network-based server infrastructure 970, on-premises servers 992, and/or components thereof).

Interface 110 may comprise an interface that enables a user and/or program of client(s) 102 to interact with taxonomy manager 112 to generate ML model(s) 120A-120N to enable AI classifier 122 to classify data into the taxonomy. In embodiments, interface 110 includes, but is not limited to, a graphical user interface (GUI), a voice interface, a chatbot interface, a chat interface, a digital assistant, a command line interface (CLI), an application programming interface (API), and/or the like. In embodiments, interface 110 may accept various inputs, such as, but not limited to, natural language descriptions of the taxonomy and/or categories and/or subcategories thereof, training data (e.g., textual data, non-textual data, URLs, patent numbers, publication identifiers, etc.). In embodiments, interface 110 interacts with taxonomy manager 112 using one or more interface requests 126 and/or one or more interface responses 128.

Application 124 may comprise various applications, such as, but not limited to, mobile applications, desktop applications, a web browser, server applications, scripts, and/or the like. In embodiments, application 124 provides, to AI classifier 122, a classification request 138 requesting a classification of data. Various example implementations of application 124 are described below in reference to FIG. 9 (e.g., application programs 914, application programs 976, application programs 996, and/or components thereof).

Network(s) 108 comprise one or more networks such as local area networks (LANs), wide area networks (WANs), enterprise networks, the Internet, etc., and may include one or more wired and/or wireless portions. In embodiments, network(s) 108 connecting client(s) 102 to server infrastructure 106 may be the same as, may overlap with, and/or may be mutually exclusive of network(s) 108 connecting client(s) 104 to server infrastructure 106. Various example implementations of network(s) 108 are described below in reference to FIG. 9 (e.g., network 904, and/or components thereof).

Server infrastructure 106 may comprise a network-accessible server set (e.g., cloud-based environment or platform). In an embodiment, the underlying resources of server infrastructure 106 are co-located (e.g., housed in one or more nearby buildings with associated components such as backup power supplies, redundant data communications, environmental controls, etc.) to form a datacenter, are distributed across different regions, and/or are arranged in other manners. Various example implementations of server infrastructure 106 are described below in reference to FIG. 9 (e.g., network-based server infrastructure 970, and/or components thereof).

Taxonomy manager 112 is configured to generate a taxonomy based on interactions with interface 110 of client(s) 102. For instance, taxonomy manager 112 receives, via interface request(s) 126, one or more of: a request to create an AI classifier for classifying information into one or more nodes of a user-provided or predetermined taxonomy, training data for one or more categories and/or subcategories of the taxonomy, natural language descriptions for one or more categories and/or subcategories of the taxonomy, and/or the like. In embodiments, taxonomy manager 112 provides an interface to enable a user of client(s) 102 to provide the structure (e.g., levels, nodes, leaves, etc.), categories (e.g., category name, category identifier, category description, etc.), and/or subcategories of the taxonomy (e.g., subcategory name, subcategory identifier, subcategory description, etc.). In embodiments, taxonomy manager 112 also provides an interface to client(s) 102 to provide training data and/or natural language definitions for categories and/or subcategories of the taxonomy.

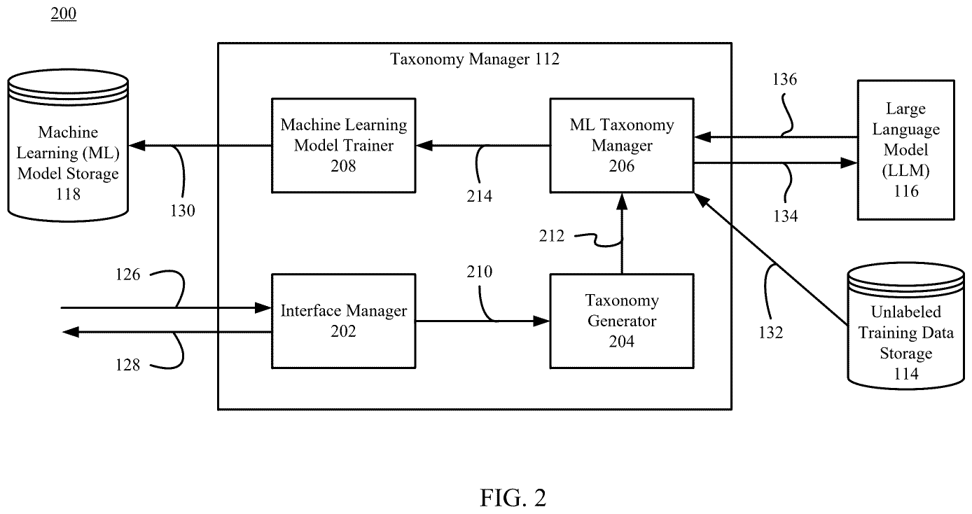

In embodiments, taxonomy manager 112 is configured to generate ML models that enable AI classifier 122 to perform AI classification responsive to a classification request 138. For instance, taxonomy manager 112 trains one or more ML models 130 based on user-provided labeled training data received from client(s) 102 via interface 110 and/or LLM-labeled training data received from LLM 116, and store trained ML model(s) 130 in ML model storage 118 for future use by AI classifier 122. In embodiments, taxonomy manager 112 determines that user-provided labeled training data includes insufficient or no training data for a first subset of the taxonomy, and selects unlabeled training data 132 from unlabeled training data storage 114 for labeling by LLM 116. In embodiments, taxonomy manager 112 provides a prompt to LLM 116 to request labeling of selected unlabeled training data 132 based on the first subset of the taxonomy. In embodiments, the first subset of the taxonomy may include a portion or all of the taxonomy. Taxonomy manager 112 will be discussed in greater detail below in conjunction with FIG. 2.

Unlabeled training data storage 114 is configured to store one or more pieces of unlabeled training data 132, such as, but not limited to, documents, files, patents, articles, webpages, and/or the like. In embodiments, unlabeled training data storage 114 comprises various data sources, such as, but not limited to, publicly available databases, proprietary databases, government databases, and/or the like.

LLM 116 may include a generic pre-trained language model trained on vast amounts of diverse data, and be enabled to perform a wide range of natural language processing tasks. In embodiments, LLM 116 is enabled to receive a prompt 134 comprising a request to label a set of unlabeled training data 132 based on a taxonomy, and return a set of LLM-labeled training data 136.

ML model storage 118 is configured to receive and store trained ML model(s) 130 for future use by AI classifier 122. In embodiments, trained ML model(s) 130 stored in ML model storage 118 may be retrieved and/or loaded from ML model storage 118 as ML model(s) 120A-120N when needed for processing classification request 138.

ML model(s) 120A-120N are configured to classify an input into a level of the taxonomy. For instance, ML model 120A classifies an input 140 into a first (e.g., top-most, etc.) level of the taxonomy by determining one or more categories in the first level of the taxonomy most appropriate to the input. In embodiments, additional ML model(s) 120B-120N classify input 140 into subsets of nodes in a subordinate level of the taxonomy that share a common parent node in the taxonomy. In embodiments, ML model(s) 120A-120N provides an ML-generated classification 142 that includes the determined classification and/or a confidence score associated with the determined classification. In embodiments, ML model(s) 120A-120N relevant to processing classification request 138 may be retrieved and/or loaded from ML model storage 118 when needed.

Model executer 146 is configured to execute ML model(s) 120A-120N. In embodiments, model executer 146 includes a model execution engine and/or framework comprising hardware and/or software to execute ML model(s) 120A-120N to accept inputs, execute model operations, and/or generate model outputs. In embodiments, ML model(s) 120A-120N are loaded from ML model storage 118 into model executer 146 to process classification request 138.

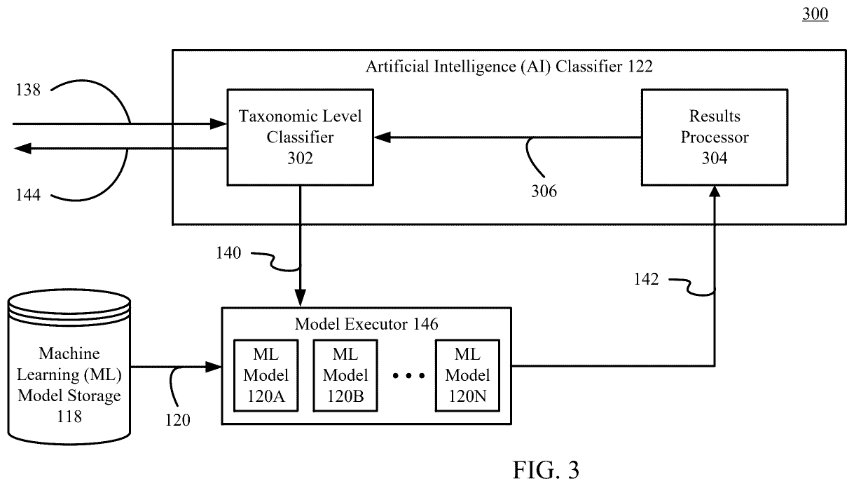

AI classifier 122 is configured to receive a classification request 138 that includes input 140 to be classified, and to classify input 140 by classifying input 140 in phases by determining a first level classification of input 140 in a first level of the taxonomy in a first phase, and then determining a second level classification of input 140 in a second level of the taxonomy that is subordinate to the first level of the taxonomy in a second phase. In embodiments, determining a second level classification of the input data in a second level of the taxonomy may be limited to subcategories in the second level of the taxonomy that are subordinate to the determined first level classification of the input data. In embodiments, AI classifier 122 provides, to client 104 via a response 144, an overall classification of input 140 associated with classification request 138. AI classifier 122 will be described in greater detail below in conjunction with FIG. 3.

Embodiments described herein may operate in various ways to generate an AI classifier. For example, FIG. 2 depicts a block diagram of an example system 200 for generating an AI classifier, in accordance with an embodiment. As shown in FIG. 2, system 200 includes taxonomy manager 112, unlabeled training data storage 114, and LLM 116, and ML model storage 118,. In system 200, taxonomy manager 112 further includes an interface manager 202, a taxonomy generator 204, a training data manager 206, and an ML model trainer 208. System 200 is described in further detail as follows.

Interface manager 202 is configured to interact with interface 110 of client(s) 102 through interface request(s) 126 and/or interface response(s) 128 to generate a new taxonomy. For instance, interface manager 202 receives, via interface request(s) 126, one or more of: a request to create an AI classifier for classifying information into one or more nodes of a user-provided or predetermined taxonomy, training data for one or more categories and/or subcategories of the taxonomy, natural language descriptions for one or more categories and/or subcategories of the taxonomy, and/or the like. In embodiments, interface manager 202 provides an interface to enable a user of client(s) 102 to provide the structure (e.g., levels, nodes, leaves, etc.), categories (e.g., category name, category identifier, category description, etc.), and/or subcategories of the taxonomy (e.g., subcategory name, subcategory identifier, subcategory description, etc.). For instance, client(s) 102 may provide training data for the categories and/or subcategories of the taxonomy to interface manager 202 in various ways, such as, but not limited to, as textual data, as non-textual data, as a file, as an identifier (e.g., patent number, publication identifier, universal resource locator (URL), etc.), and/or the like. For instance, training data provided as patent numbers, publication identifiers, and/or URL may cause interface manager 202 to retrieve textual data (e.g., article, patent, etc.) associated therewith. In embodiments, interface manager 202 processes training data provided as non-textual data (e.g., images, videos, audio, etc.) to generate a textual description of the non-textual data. In embodiments, interface manager 202 provides taxonomy data 210 to taxonomy generator 204 to enable taxonomy generator 204 to generate a taxonomy.

Taxonomy generator 204 is configured to generate a new taxonomy based on taxonomy data 210 determined by interface manager 202 through interactions with client(s) 102. In embodiments, taxonomy generator 204 receives, for categories and/or subcategories of the taxonomy, user-provided labeled training data and/or natural language definitions. In embodiments, taxonomy generator 204 organizes taxonomy data 210 into a taxonomy data structure 212 by organizing the categories and/or subcategories into a plurality of nodes, connecting categories and subcategories with edges representative of ancestor-descendant relationships, associating natural language definitions of categories and/or subcategories with nodes corresponding to the categories and/or subcategories, and/or associated user-provided labeled training data for categories and/or subcategories with nodes corresponding to the categories and/or subcategories. In embodiments, taxonomy generator 204 provides taxonomy data structure 212 to training data manager 206 and/or training data manager 206.

Training data manager 206 is configured to receive taxonomy data structure 212 from taxonomy generator 204, and generate one or more training datasets 214 that comprise user-provided labeled training data included in taxonomy data structure 212. In embodiments, training data manager 206 analyzes taxonomy data structure 212 to determine nodes (e.g., leaf nodes, etc.) of the taxonomy that are associated with insufficient labeled training data, and select unlabeled training data for the determined nodes.

In embodiments, training data manager 206 selects unlabeled training data 132 from unlabeled training data storage 114 for inclusion in training dataset(s) 214. For instance, training data manager 206 selects unlabeled training data 132 for labeling by the LLM 116 based on a likely classification of the unlabeled training data 132. For instance, training data manager 206 determines that a node (e.g., leaf node) of the taxonomy lacks has insufficient and/or not labeled training data, and selects unlabeled training data 132 that likely belongs to the node of taxonomy based on classification scores associated with the unlabeled training data 132. In embodiments, training data manager 206 concatenates textual sections (e.g., abstract, description, conclusion, claims, etc.) of unlabeled training data 132 to generate concatenated text, and generates overlapping chunks from the concatenated text for scoring. In embodiments, training data manager 206 determines classification sub-scores for the overlapping chunks based on a distance (e.g., cosine distance, Euclidean distance, etc.) between an embedding of the chunks and an embedding of a textual description of the node of taxonomy. In embodiments, training data manager 206 determines classification scores for unlabeled training data 132 as the highest classification sub-score of the overlapping chunks. In embodiments, training data manager 206 ranks unlabeled training data 132 based on the classification scores for the node of taxonomy and selects a number of unlabeled training data 132 for the node of taxonomy in order to achieve a training data threshold.

In embodiments, training data manager 206 provides the selected unlabeled training data 132 along with the taxonomy to LLM 116 for labeling. In embodiments, training data manager 206 provides a textual prompt 134 to LLM 116 requesting LLM 116 to label the selected unlabeled training data 132 based on the taxonomy. For instance, an example prompt 134 may include “Please label the following unlabeled training data using one or more categories in the following taxonomy.” In embodiments, training data manager 206 receives LLM-labeled training data 136 from LLM 116, and generates training dataset(s) 214 based on user-provided labeled training data and LLM-labeled training data 136.

In embodiments, training data manager 206 organizes training dataset(s) 214 based on levels of the taxonomy. For instance, a first training dataset 214 comprises labeled training data associated with a first (e.g., top-most, etc.) level of the taxonomy. In embodiments, nodes of the taxonomy inherit training data associated with subordinate (e.g., child, etc.) nodes in the taxonomy. In embodiments, additional training dataset(s) 214 comprise labeled training data associated with a subset of nodes in a subordinate level of the taxonomy that share a common parent node. In embodiments, training data manager 206 provides training dataset(s) 214 to ML model trainer 208.

ML model trainer 208 is configured to generate trained ML model(s) 130 using supervised machine learning techniques based on training dataset(s) 214 that comprises user-provided labeled training data and/or LLM-labeled training data 136. In embodiments, ML model trainer 208 divides a training dataset 214 into a first subset training dataset for training and a second subset validation dataset for validation. In embodiments, ML model trainer 208 trains an ML model by iteratively adjusting the parameters of the ML model to minimize a loss function between its predicted classification and the actual classification in the training dataset. ML model trainer 208, in embodiments, then validates the performance of the ML model by evaluating the ML model on the second subset validation dataset to assess its ability to accurately classify new or unseen data. In embodiments, ML model trainer 208 performs supervised training based on various ML algorithms, such as, but not limited to, support vector machines (SVM), logistic regression, decision trees, random forest, k-nearest neighbors (KNN), Naïve Bayes, gradient boosting, neural networks, and/or the like. ML model trainer 208, in embodiments, trains the ML models until a training termination condition is satisfied, including, but not limited to, until there are no additional levels of the taxonomy, until the accuracy of the classification fails to satisfy a predetermined accuracy threshold, until the number of levels classified by the AI classifier exceeds a classification depth threshold, and/or the like. In embodiments, ML model trainer 208 stores trained ML model(s) 130 in ML model storage 118 for future use by AI classifier 122.

Embodiments described herein may operate in various ways to classify an input using an AI classifier. For example, FIG. 3 depicts a block diagram of an example system 300 for classifying an input using an AI classifier, in accordance with an embodiment. As shown in FIG. 3, system 300 includes ML model storage 118, ML model storage 118, ML model(s) 120A-120N, model executer 146, and AI classifier 122. In system 300, AI classifier 122 further includes a taxonomic level classifier 302, and a results processor 304. System 300 is described in further detail as follows.

Taxonomic level classifier 302 is configured to receive classification request 138 to classify input 140 into the taxonomy, and iteratively classify input 140 into one or more levels of the taxonomy. In embodiments, taxonomic level classifier 302 classifies input 140 into a first level of the taxonomy based on a first classification of input 140 generated by ML model 120A trained to classify data into a first level of a first portion of the taxonomy. For instance, taxonomic level classifier 302 loads ML model 120A from ML model storage 118 into model executer 146, and provides input 140 to ML model 120A trained to classify data into a first level of a first portion of the taxonomy. Taxonomic level classifier 302, in embodiments, receives, from results processor 304, a level classification 306 of input 140 in the first level of the taxonomy based on the first classification of input 140 generated by ML model 120A.

In embodiments, taxonomic level classifier 302 may classify input 140 into a second level of the taxonomy based on a second classification of input 140 generated by ML model 120B trained to classify data into a second level of the first portion of the taxonomy. For instance, taxonomic level classifier 302 may load ML model 120B from ML model storage 118 into model executer 146, and provide input 140 to ML model 120B for classification into a second level of the first portion of the taxonomy. Taxonomic level classifier 302, in embodiments, receives, from results processor 304, a level classification 306 of input 140 in the second level of the taxonomy determined based on the second classification of input 140 generated by ML model 120B.

In embodiments, taxonomic level classifier 302 classifies input 140 into additional levels of the taxonomy in a similar manner using additional ML model(s) (e.g., ML model 120N) until a classification termination condition is satisfied, for example, but not limited to, until the latest level classification of input 140 in the taxonomy does not contain any subordinate subcategories, until a classification detail threshold is satisfied, until an accuracy or confidence score associated with the latest level classification fails to satisfy an accuracy or confidence threshold, and/or the like. Upon satisfaction of the termination condition, taxonomic level classifier 302, in embodiments, provides, to client 104 via response 144, an overall classification of input 140 that comprises one or more level classifications 306 corresponding to one or more levels of the taxonomy.

Results processor 304 is configured to receive ML-generated classification 142 from ML model(s) 120A-120N, and provides ML-generated classification 142 to taxonomic level classifier 302 as level classification 306.

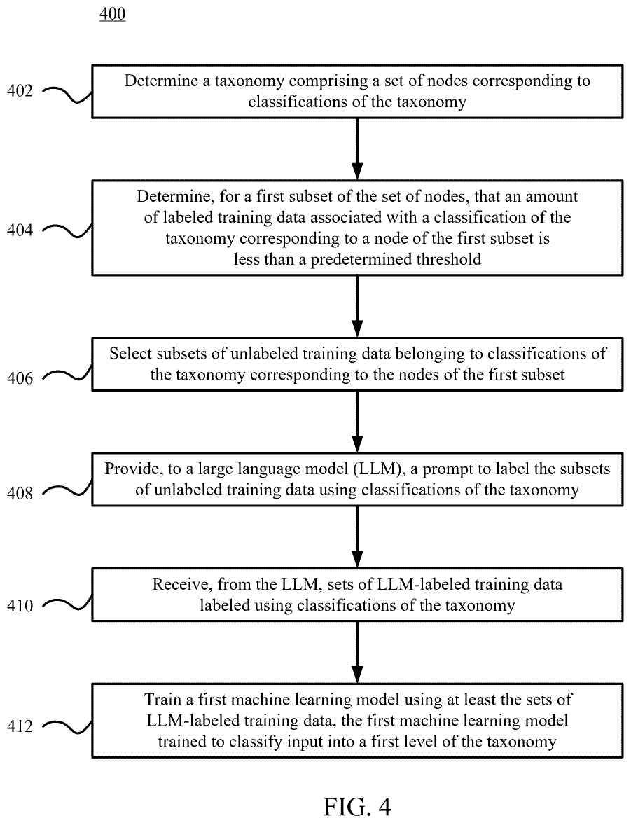

Embodiments described herein may operate in various ways to train an ML model using LLM-labeled training data. FIG. 4 depicts a flowchart 400 of a process for training an ML model using LLM-labeled training data, in accordance with an embodiment. Server infrastructure 106, taxonomy manager 112, ML model storage 118, ML model(s) 120A-120N, AI classifier 122, interface manager 202, taxonomy generator 204, unlabeled training data storage 114, training data manager 206, LLM 116, and/or ML model trainer 208 of FIGS. 1-2 may operate in accordance with flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402. In step 402, a taxonomy is determined, the taxonomy comprising a set of nodes corresponding to classifications of the taxonomy. For example, interface manager 202 interacts with interface 110 of client(s) 102 through interface request(s) 126 and/or interface response(s) 128 to determine a taxonomy. In embodiments, interface manager 202 provides an interface to enable a user of client(s) 102 to provide the structure (e.g., levels, nodes, leaves, etc.), categories (e.g., category name, category identifier, category description, etc.), and/or subcategories of the taxonomy (e.g., subcategory name, subcategory identifier, subcategory description, etc.).

In step 404, for a first subset of the set of nodes, an amount of labeled training data associated with a classification of the taxonomy corresponding to a node of the first subset is determined to be less than a predetermined threshold. For example, training data manager 206 determines that an amount of labeled training data associated with a node of taxonomy data structure 212 is less than a predetermined threshold.

In step 406, subsets of unlabeled training data belonging to the classifications of the taxonomy corresponding to the nodes of the first subset are selected. For example, training data manager 206 selects unlabeled training data 132 for labeling by the LLM 116 based on a likely classification of the unlabeled training data 132. In embodiments, training data manager 206 concatenates textual sections (e.g., abstract, description, conclusion, claims, etc.) of unlabeled training data 132 to generate concatenated text, and generates overlapping chunks from the concatenated text for scoring. In embodiments, training data manager 206 determines classification sub-scores for the overlapping chunks based on a distance (e.g., cosine distance, Euclidean distance, etc.) between an embedding of the chunks and an embedding of a textual description of the node of the taxonomy. In embodiments, training data manager 206 determines classification scores for unlabeled training data 132 as the highest classification sub-score of the overlapping chunks. In embodiments, training data manager 206 ranks unlabeled training data 132 based on the classification scores for the node of the taxonomy and selects a number of unlabeled training data 132 for the node of the taxonomy in order to achieve a training data threshold

In step 408, a prompt is provided to an LLM to label the subsets of unlabeled training data using classifications of the taxonomy. For example, training data manager 206 provides a textual prompt 134 to LLM 116 requesting LLM 116 to label the selected unlabeled training data 132 based on the taxonomy.

In step 410, sets of LLM-labeled training data labeled using classifications of the taxonomy are received from the LLM. For example, training data manager 206 receives LLM-labeled training data 136 from LLM 116, and provides LLM-labeled training data 136 to ML trainer 208 as part of training dataset(s) 214.

In step 412, a first ML model is trained using at least the sets of LLM-labeled training data, the first ML model trained to classify input into a first level of the taxonomy. For example, ML model trainer 208 trains ML model(s) 130 using supervised machine learning techniques based on training dataset(s) 214 that comprise at least LLM-labeled training data 136.

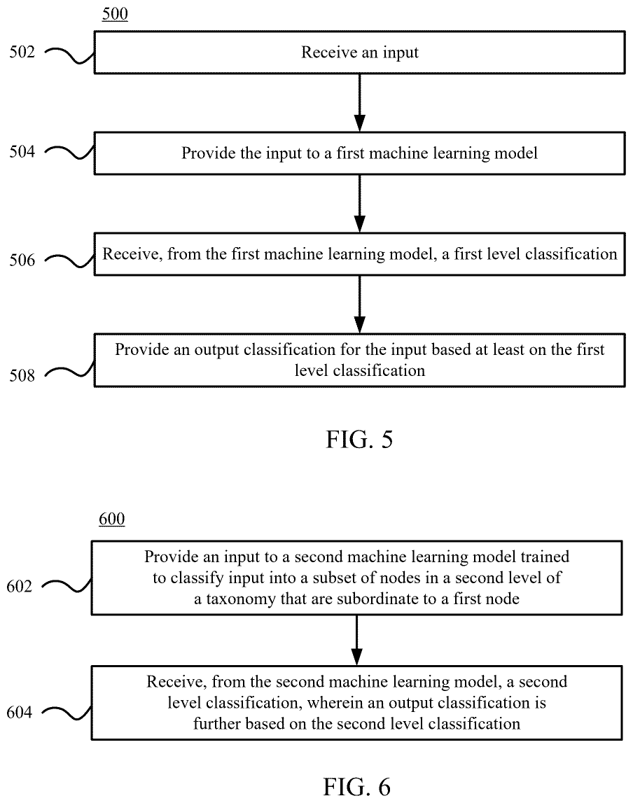

Embodiments described herein may operate in various ways to classify an input into a first level of a taxonomy. FIG. 5 depicts a flowchart 500 of a process for classifying an input into a first level of a taxonomy, in accordance with an embodiment. Server infrastructure 106, ML model storage 118, ML model(s) 120A-120N, model executer 146, AI classifier 122, taxonomic level classifier 302, and/or results processor 304 of FIGS. 1 and 3 may operate in accordance with flowchart 500. Note that not all steps of flowchart 500 may need to be performed in all embodiments, and in some embodiments, the steps of flowchart 500 may be performed in different orders than shown. Flowchart 500 is described as follows with respect to FIGS. 1 and 3 for illustrative purposes.

Flowchart 500 starts at step 502. In step 502, an input is received. For example, taxonomic level classifier 302 receives input 140 from client(s) 104 as part of classification request 138.

In step 504, the input is provided to a first ML model. For example, taxonomic level classifier 302 provides input 140 to ML model 120A trained to classify data into a first level of a taxonomy.

In step 506, a first level classification of the input is received from the first ML model. For example, results processor 304 receives, from ML model 120A, ML-generated classification 142 that includes a first level classification.

In step 508, an output classification is provided the input based at least on the first level classification. For example, results processor 304 provides level classification 306 based at least on ML-generated classification 142.

Embodiments described herein may operate in various ways to classify an input into a second level of a taxonomy. FIG. 6 depicts a flowchart 600 of a process for classifying an input into a second level of a taxonomy, in accordance with an embodiment. Server infrastructure 106, ML model storage 118, ML model(s) 120A-120N, model executer 146, AI classifier 122, taxonomic level classifier 302, and/or results processor 304 of FIGS. 1 and 3 may operate in accordance with flowchart 600. Note that not all steps of flowchart 600 may need to be performed in all embodiments, and in some embodiments, the steps of flowchart 600 may be performed in different orders than shown. Flowchart 600 is described as follows with respect to FIGS. 1 and 3 for illustrative purposes.

Flowchart 600 starts at step 602. In step 602, an input is provided to a second machine learning model trained to classify input into a subset of nodes in a second level of a taxonomy that are subordinate to a first node associated with a first level classification. For example, taxonomic level classifier 302 provides input 140 to ML model 120B trained to classify data into a subset of nodes in a second level of a taxonomy subordinate to a first node associated with a first level classification.

In step 604, a second level classification is received from the second ML model, wherein an output classification is further based on the second level classification.

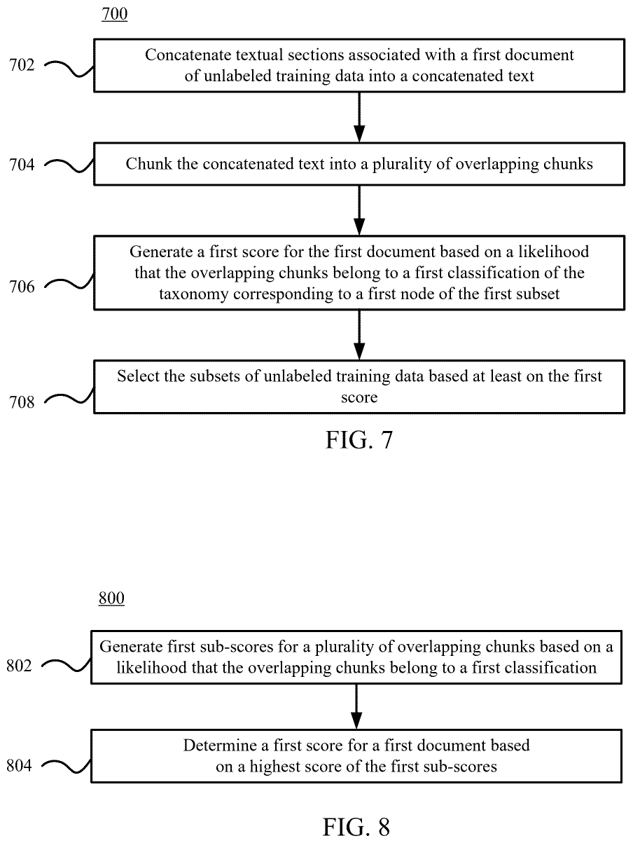

Embodiments described herein may operate in various ways to select unlabeled training data for labeling by an LLM. For example, FIG. 7 depicts a flowchart 700 of a process for selecting unlabeled training data for labeling by an LLM, in accordance with an embodiment. Server infrastructure 106, taxonomy manager 112, and/or training data manager 206 of FIGS. 1-2 may operate in accordance with flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1-2 for illustrative purposes.

Flowchart 700 starts at step 702. In step 702, textual sections associated with a first document of unlabeled training data are concatenated into a concatenated text. For example, training data manager 206 concatenates textual sections (e.g., abstract, description, conclusion, claims, etc.) of unlabeled training data 132 to generate concatenated text.

In step 704, the concatenated text is chunked into a plurality of overlapping chunks. For example, training data manager 206 generates overlapping chunks from the concatenated text for scoring.

In step 706, a first score for the first document is generated based on a likelihood that the overlapping chunks belong to a first classification of the taxonomy corresponding to a first node of a first subset. For example, training data manager 206 determines classification scores for unlabeled training data.

In step 708, the subsets of unlabeled training data are selected based at least on the first score. For example, training data manager 206 ranks unlabeled training data 132 based on the classification scores for the node of the taxonomy and selects a number of unlabeled training data 132 for the node.

Embodiments described herein may operate in various ways to generate a classification score for unlabeled training data. FIG. 8 depicts a flowchart 800 of a process for generating a classification score for unlabeled training data, in accordance with an embodiment. Server infrastructure 106, taxonomy manager 112, and/or training data manager 206 of FIGS. 1-2 may operate in accordance with flowchart 800. Flowchart 800 is described as follows with respect to FIGS. 1-2 for illustrative purposes.

Flowchart 800 starts at step 802. In step 802, first sub-scores are generated for a plurality of overlapping chunks based on a likelihood that the overlapping chunks belong to a first classification. For example, training data manager 206 determines classification sub-scores for the overlapping chunks based on a distance (e.g., cosine distance, Euclidean distance, etc.) between an embedding of the chunks and an embedding of a textual description of the node of the taxonomy.

In step 804, a first score is determined for a first document based on a highest score of the first sub-scores. For example, training data manager 206 determines classification scores for unlabeled training data 132 as the highest classification sub-score of the overlapping chunks.

### III. Example Mobile Device and Computer System Implementation

The systems and methods described above in reference to FIGS. 1-8, including client(s) 102, client(s) 104, server infrastructure 106, network(s) 108, interface 110, taxonomy manager 112, unlabeled training data storage 114, LLM 116, ML model storage 118, ML model(s) 120A-120N, model executer 146, AI classifier 122, application 124, interface manager 202, taxonomy generator 204, training data manager 206, ML model trainer 208, taxonomic level classifier 302, results processor 304, and/or each of the components described therein, and/or the steps of flowcharts 400, 500, 600, 700, and/or 800 may be implemented in hardware, or hardware combined with one or both of software and/or firmware. For example, client(s) 102, client(s) 104, server infrastructure 106, network(s) 108, interface 110, taxonomy manager 112, unlabeled training data storage 114, LLM 116, ML model storage 118, ML model(s) 120A-120N, model executer 146, AI classifier 122, application 124, interface manager 202, taxonomy generator 204, training data manager 206, ML model trainer 208, taxonomic level classifier 302, results processor 304, and/or each of the components described therein, and/or the steps of flowcharts 400, 500, 600, 700, and/or 800 may be each implemented as computer program code/instructions configured to be executed in one or more processors and stored in a computer readable storage medium. Alternatively, client(s) 102, client(s) 104, server infrastructure 106, network(s) 108, interface 110, taxonomy manager 112, unlabeled training data storage 114, LLM 116, ML model storage 118, ML model(s) 120A-120N, model executer 146, AI classifier 122, application 124, interface manager 202, taxonomy generator 204, training data manager 206, ML model trainer 208, taxonomic level classifier 302, results processor 304, and/or each of the components described therein, and/or the steps of flowcharts 400, 500, 600, 700, and/or 800 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 9. FIG. 9 shows a block diagram of an exemplary computing environment 900 that includes a computing device 902. Computing device 902 is an example of client(s) 102 and/or client(s) 104 shown in FIG. 1, which may each include one or more of the components of computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc., and may include one or more wired and/or wireless portions. Network 904 may additionally or alternatively include a cellular network for cellular communications. Computing device 902 is described in detail as follows.

Computing device 902 can be any of a variety of types of computing devices. For example, computing device 902 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 902 may alternatively be a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, one or more input devices 950, one or more output devices 950, one or more wireless modems f0, one or more wired interfaces 960, a power supply 962, a location information (LI) receiver 964, and an accelerometer 966. Storage 920 includes memory 956, which includes non-removable memory 922 and removable memory 924, and a storage device 990. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 950 includes a touch screen 952, a microphone 954, a camera 956, a physical keyboard 958, and a trackball 940. Not all components of computing device 902 shown in FIG. 9 are present in all embodiments, additional components not shown may be present, and any combination of the components may be present in a particular embodiment. These components of computing device 902 are described as follows.

A single processor 910 (e.g., central processing unit (CPU), microcontroller, a microprocessor, signal processor, ASIC (application specific integrated circuit), and/or other physical hardware processor circuit) or multiple processors 910 may be present in computing device 902 for performing such tasks as program execution, signal coding, data processing, input/output processing, power control, and/or other functions. Processor 910 may be a single-core or multi-core processor, and each processor core may be single-threaded or multithreaded (to provide multiple threads of execution concurrently). Processor 910 is configured to execute program code stored in a computer readable medium, such as program code of operating system 912 and application programs 914 stored in storage 920. The program code is structured to cause processor 910 to perform operations, including the processes/methods disclosed herein. Operating system 912 controls the allocation and usage of the components of computing device 902 and provides support for one or more application programs 914 (also referred to as “applications” or “apps”). Application programs 914 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 910 may include one or more general processors (e.g., CPUs) configured with or coupled to one or more hardware accelerators, such as one or more NPUs and/or one or more GPUs.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) that may be present to communicatively couple processor 910 to various other components of computing device 902, although in other embodiments, an alternative bus, further buses, and/or one or more individual signal lines may be present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 990, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 922 may include main memory and may be separate from or fabricated in a same integrated circuit as processor 910. As shown in FIG. 9, non-removable memory 922 stores firmware 918, which may be present to provide low-level control of hardware. Examples of firmware 918 include BIOS (Basic Input/Output System, such as on personal computers) and boot firmware (e.g., on smart phones). Removable memory 924 may be inserted into a receptacle of or otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 990 may be present that are internal and/or external to a housing of computing device 902 and may or may not be removable. Examples of storage device 990 include a hard disk drive, a SSD, a thumb drive (e.g., a USB (Universal Serial Bus) flash drive), or other physical storage device.

One or more programs may be stored in storage 920. Such programs include operating system 912, one or more application programs 914, and other program modules and program data. Examples of such application programs may include, for example, computer program logic (e.g., computer program code/instructions) for implementing client(s) 102, client(s) 104, server infrastructure 106, network(s) 108, interface 110, taxonomy manager 112, unlabeled training data storage 114, LLM 116, ML model storage 118, ML model(s) 120A-120N, model executer 146, AI classifier 122, application 124, interface manager 202, taxonomy generator 204, training data manager 206, ML model trainer 208, taxonomic level classifier 302, results processor 304, and/or each of the components described therein, as well as any of flowcharts 400, 500, 600, 700, and/or 800, and/or any individual steps thereof.

Storage 920 also stores data used and/or generated by operating system 912 and application programs 914 as application data 916. Examples of application data 916 include web pages, text, images, tables, sound files, video data, and other data, which may also be sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 902 through one or more input devices 950 and may receive information from computing device 902 through one or more output devices 950. Input device(s) 950 may include one or more of touch screen 952, microphone 954, camera 956, physical keyboard 958 and/or trackball 940 and output device(s) 950 may include one or more of speaker 952 and display 954. Each of input device(s) 950 and output device(s) 950 may be integral to computing device 902 (e.g., built into a housing of computing device 902) or external to computing device 902 (e.g., communicatively coupled wired or wirelessly to computing device 902 via wired interface(s) 960 and/or wireless modem(s) 960). Further input devices 950 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 may display information, as well as operating as touch screen 952 by receiving user commands and/or other information (e.g., by touch, finger gestures, virtual keyboard, etc.) as a user interface. Any number of each type of input device(s) 950 and output device(s) 950 may be present, including multiple microphones 954, multiple cameras 956, multiple speakers 952, and/or multiple displays 954.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). Wireless modem 960 may also or alternatively include other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 962, LI receiver 964, accelerometer 966, and/or one or more wired interfaces 960. Example wired interfaces 960 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 960 of computing device 902 provide for wired connections between computing device 902 and network 904, or between computing device 902 and one or more devices/peripherals when such devices/peripherals are external to computing device 902 (e.g., a pointing device, display 954, speaker 952, camera 956, physical keyboard 958, etc.). Power supply 962 is configured to supply power to each of the components of computing device 902 and may receive power from a battery internal to computing device 902, and/or from a power cord plugged into a power port of computing device 902 (e.g., a USB port, an A/C power port). LI receiver 964 may be used for location determination of computing device 902 and may include a satellite navigation receiver such as a Global Positioning System (GPS) receiver or may include other type of location determiner configured to determine location of computing device 902 based on received information (e.g., using cell tower triangulation, etc.). Accelerometer 966 may be present to determine an orientation of computing device 902.

Note that the illustrated components of computing device 902 are not required or all-inclusive, and fewer or greater numbers of components may be present as would be recognized by one skilled in the art. For example, computing device 902 may also include one or more of a gyroscope, barometer, proximity sensor, ambient light sensor, digital compass, etc. Processor 910 and memory 956 may be co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein may be stored in storage 920 and executed by processor 910.

In some embodiments, server infrastructure 970 may be present in computing environment 900 and may be communicatively coupled with computing device 902 via network 904. Server infrastructure 970, when present, may be a network-accessible server set (e.g., a cloud-based environment or platform). As shown in FIG. 9, server infrastructure 970 includes clusters 972. Each of clusters 972 may comprise a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. Any of nodes 974 may be a storage node that comprises a plurality of physical storage disks, SSDs, and/or other physical storage devices that are accessible via network 904 and are configured to store data associated with the applications and services managed by nodes 974. For example, as shown in FIG. 9, nodes 974 may store application data 978.

Each of nodes 974 may, as a compute node, comprise one or more server computers, server systems, and/or computing devices. For instance, a node 974 may include one or more of the components of computing device 902 disclosed herein. Each of nodes 974 may be configured to execute one or more software applications (or “applications”) and/or services and/or manage hardware resources (e.g., processors, memory, etc.), which may be utilized by users (e.g., customers) of the network-accessible server set. For example, as shown in FIG. 9, nodes 974 may operate application programs 976. In an implementation, a node of nodes 974 may operate or comprise one or more virtual machines, with each virtual machine emulating a system architecture (e.g., an operating system), in an isolated manner, upon which applications such as application programs 976 may be executed.

In an embodiment, one or more of clusters 972 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 972 may be a datacenter in a distributed collection of datacenters. In embodiments, exemplary computing environment 900 comprises part of a cloud-based platform.

In an embodiment, computing device 902 may access application programs 976 for execution in any manner, such as by a client application and/or a browser at computing device 902.

For purposes of network (e.g., cloud) backup and data security, computing device 902 may additionally and/or alternatively synchronize copies of application programs 914 and/or application data 916 to be stored at network-based server infrastructure 970 as application programs 976 and/or application data 978. For instance, operating system 912 and/or application programs 914 may include a file hosting service client configured to synchronize applications and/or data stored in storage 920 at network-based server infrastructure 970.

In some embodiments, on-premises servers 992 may be present in computing environment 900 and may be communicatively coupled with computing device 902 via network 904. On-premises servers 992, when present, are hosted within an organization's infrastructure and, in many cases, physically onsite of a facility of that organization. On-premises servers 992 are controlled, administered, and maintained by IT (Information Technology) personnel of the organization or an IT partner to the organization. Application data 998 may be shared by on-premises servers 992 between computing devices of the organization, including computing device 902 (when part of an organization) through a local network of the organization, and/or through further networks accessible to the organization (including the Internet). Furthermore, on-premises servers 992 may serve applications such as application programs 996 to the computing devices of the organization, including computing device 902. Accordingly, on-premises servers 992 may include storage 994 (which includes one or more physical storage devices such as storage disks and/or SSDs) for storage of application programs 996 and application data 998 and may include one or more processors for execution of application programs 996. Still further, computing device 902 may be configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 may be used to implement systems, clients, or devices, or components/subcomponents thereof, disclosed elsewhere herein. In other embodiments, a combination of computing device 902, network-based server infrastructure 970, and/or on-premises servers 992 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 914) may be stored in storage 920. Such computer programs may also be received via wired interface(s) 960 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
a processor; and
a memory device that stores program code structured to cause the processor to:
determine a taxonomy comprising a set of nodes corresponding to classifications of the taxonomy;
determine, for a first subset of the set of nodes, that an amount of labeled training data associated with a classification of the taxonomy corresponding to a node of the first subset is less than a predetermined threshold;
select subsets of unlabeled training data belonging to classifications of the taxonomy corresponding to the nodes of the first subset;
provide, to a large language model (LLM), a prompt to label the subsets of unlabeled training data using classifications of the taxonomy;
receive, from the LLM, sets of LLM-labeled training data labeled using classifications of the taxonomy; and
train a first machine learning model using at least the sets of LLM-labeled training data, the first machine learning model trained to classify input into a first level of the taxonomy.

2. The system of claim 1, wherein, to select subsets of unlabeled training data, the program code is structured to cause the processor to:
concatenate textual sections associated with a first document of the unlabeled training data into a concatenated text;
chunk the concatenated text into a plurality of overlapping chunks;
generate a first score for the first document based on the likelihood that the overlapping chunks belong to a first classification of the taxonomy corresponding to a first node of the first subset; and
select the subsets of unlabeled training data based at least on the first score.

3. The system of claim 2, wherein, to generate a first score for the first document, the program code is structured to cause the processor to:
generate first sub-scores for the plurality of overlapping chunks based on the likelihood that the overlapping chunks belong to the first classification; and
determine the first score for the first document based a highest score of the first sub-scores.

4. The system of claim 1, wherein the program code is structured to further cause the processor to:
receive an input;
provide the input to the first machine learning model;
receive, from the first machine learning model, a first level classification associated with a first node in the first level of the taxonomy; and
provide an output classification for the input based at least on the first level classification.

5. The system of claim 4, wherein the program code is structured to further cause the processor to:
provide the input to a second machine learning model trained to classify input into a subset of nodes in a second level of the taxonomy that are subordinate to the first node;
and receive, from the second machine learning model, a second level classification,
wherein the output classification is further based on the second level classification.

6. The system of claim 1, wherein the labeled training data comprises at least one of:
user-provided training data associated with the first node; or
training data retrieved based on a user-provided document identifier and associated with the first node, the user-provided document identifier comprising at least one of: a publication identifier, or a patent number.

7. The system of claim 1, wherein, to determine the taxonomy, the program code is structured to cause the process to perform at least one of:
receive, from a user via a user interface, at least a portion of the taxonomy;
automatically generate at least a portion of the taxonomy based on user input; or
generate at least a portion of the taxonomy based on user modifications to a previously generated taxonomy,
wherein the taxonomy is a hierarchical taxonomy.

8. A method comprising:
determining a taxonomy comprising a set of nodes corresponding to classifications of the taxonomy;
determining, for a first subset of the set of nodes, that an amount of labeled training data associated with a classification of the taxonomy corresponding to a node of the first subset is less than a predetermined threshold;
selecting subsets of unlabeled training data belonging to classifications of the taxonomy corresponding to the nodes of the first subset;
providing, to a large language model (LLM), a prompt to label the subsets of unlabeled training data using classifications of the taxonomy;
receiving, from the LLM, sets of LLM-labeled training data labeled using classifications of the taxonomy; and
training a first machine learning model using at least the sets of LLM-labeled training data, the first machine learning model trained to classify input into a first level of the taxonomy.

9. The method of claim 8, wherein said selecting subsets of unlabeled training data comprises:
concatenating textual sections associated with a first document of the unlabeled training data into a concatenated text;
chunking the concatenated text into a plurality of overlapping chunks;
generating a first score for the first document based on the likelihood that the overlapping chunks belong to a first classification of the taxonomy corresponding to a first node of the first subset; and
selecting the subsets of unlabeled training data based at least on the first score.

10. The method of claim 8, wherein said generating a first score for the first document comprises:
generating first sub-scores for the plurality of overlapping chunks based on the likelihood that the overlapping chunks belong to the first classification; and
determining the first score for the first document based a highest score of the first sub-scores.

11. The method of claim 8, further comprising:
receiving an input;
providing the input to the first machine learning model;
receiving, from the first machine learning model, a first level classification associated with a first node in the first level of the taxonomy; and
providing an output classification for the input based at least on the first level classification.

12. The method of claim 11, further comprising:
providing the input to a second machine learning model trained to classify input into a subset of nodes in a second level of the taxonomy that are subordinate to the first node; and
receiving, from the second machine learning model, a second level classification,
wherein the output classification is further based on the second level classification.

13. The method of claim 8, wherein the labeled training data comprises at least one of:
user-provided training data associated with the first node; or
training data retrieved based on a user-provided document identifier and associated with the first node, the user-provided document identifier comprising at least one of: a publication identifier, or a patent number.

14. The method of claim 8, wherein said determining the taxonomy comprises at least one of:
receiving, from a user via a user interface, at least a portion of the taxonomy;
automatically generating at least a portion of the taxonomy based on user input; or
generating at least a portion of the taxonomy based on user modifications to a previously generated taxonomy,
wherein the taxonomy is a hierarchical taxonomy.

15. A computer-readable storage medium comprising executable instructions that, when executed by a processor, cause the processor to:
determine a taxonomy comprising a set of nodes corresponding to classifications of the taxonomy;
determine, for a first subset of the set of nodes, that an amount of labeled training data associated with a classification of the taxonomy corresponding to a node of the first subset is less than a predetermined threshold;
select subsets of unlabeled training data belonging to classifications of the taxonomy corresponding to the nodes of the first subset;
provide, to a large language model (LLM), a prompt to label the subsets of unlabeled training data using classifications of the taxonomy;
receive, from the LLM, sets of LLM-labeled training data labeled using classifications of the taxonomy; and
train a first machine learning model using at least the sets of LLM-labeled training data, the first machine learning model trained to classify input into a first level of the taxonomy.

16. The computer-readable storage medium of claim 15, wherein, to select subsets of unlabeled training data, the executable instructions, when executed by the processor, cause the processor to:
concatenate textual sections associated with a first document of the unlabeled training data into a concatenated text;
chunk the concatenated text into a plurality of overlapping chunks;
generate a first score for the first document based on the likelihood that the overlapping chunks belong to a first classification of the taxonomy corresponding to a first node of the first subset; and
select the subsets of unlabeled training data based at least on the first score.

17. The computer-readable storage medium of claim 16, wherein, to generate a first score for the first document, the executable instructions, when executed by the processor, cause the processor to:
generate first sub-scores for the plurality of overlapping chunks based on the likelihood that the overlapping chunks belong to the first classification; and
determine the first score for the first document based a highest score of the first sub-scores.

18. The computer-readable storage medium of claim 15, wherein the executable instructions, when executed by the processor, further cause the processor to:
receive an input;
provide the input to the first machine learning model;
receive, from the first machine learning model, a first level classification associated with a first node in the first level of the taxonomy; and
provide an output classification for the input based at least on the first level classification.

19. The computer-readable storage medium of claim 18, wherein executable instructions, when executed by the processor, further cause the processor to:
provide the input to a second machine learning model trained to classify input into a subset of nodes in a second level of the taxonomy that are subordinate to the first node;
and receive, from the second machine learning model, a second level classification,
wherein the output classification is further based on the second level classification.

20. The computer-readable storage medium of claim 15, wherein the labeled training data comprises at least one of:
user-provided training data associated with the first node; or
training data retrieved based on a user-provided document identifier and associated with the first node, the user-provided document identifier comprising at least one of: a publication identifier, or a patent number.
